(19) United States
(12) Patent Application Publication
(10) Pub. No.: US 2026/0099183 A1
(43) Pub. Date: Apr. 9, 2026

(54) Energy Dispatch for Data Centers

(71) Applicant: Verrus, LLC, Beverly Hills, CA (US)

(72) Inventors: Matthieu Frederic Jean-Jacques Monsch, Seattle, WA (US); Christopher Alan Coco, San Francisco, CA (US); Anand Ramesh, Los Altos, CA (US); Jimmy Clidaras, Boca Raton, FL (US); Saurav Talukdar, San Jose, CA (US); Jeremy Alan Rice, Santa Monica, CA (US); Nelson Louis Abramson, Beverly Hills, CA (US); Benjamin Ray Wheeler, San Francisco, CA (US); Nithya Manickam, Redwood City, CA (US); Carlos Rios, San Mateo, CA (US)

(21) Appl. No.: 18/905,674

(22) Filed: Oct. 3, 2024

(51) Int. Cl. G06F 1/26; G06F 9/48

(52) U.S. Cl. CPC G06F 1/266; G06F 9/4893

(57) ABSTRACT

A computer-implemented system for dispatching devices in a computer data center, has a plurality of energy-using devices, a plurality of energy-providing devices, and a dispatcher programmed to (a) identify future energy loads for the computer data center and available energy-using and energy-generating devices using data received from sources internal to the computer data center and sources external to the computer data center, (b) select particular ones of the available energy-using and energy-generating devices to serve the identified future energy loads, and (c) generate control signals to cause the selected particular ones of the available energy-using and energy-generating devices to serve the identified future energy loads.

### TECHNICAL FIELD

This document generally describes technology related to dispatching energy-providing and energy-using devices that serve different, geographically-dispersed computer data centers.

### BACKGROUND

Computer data centers continue to grow in their size and importance to the economy. Many now cost over $1 billion to construct and bring to operation (and often much more), with hundreds or thousands of computer racks inside, and hundreds of thousands of processors (e.g., for processing search queries or other requests in real-time or training AI models over a longer period with a more flexible schedule).

High levels of computer processing generally require relatively high levels of electrical power input to operate the computers in a data center. The conversion of that electricity to computing work then creates heat, and that heat needs to be dispersed. Cooling systems (with, e.g., fans, pumps, and compressors) can then require additional electrical power to perform such dissipation of heat. Additional auxiliary systems may further require electrical power, such as for lighting, control systems, and equipment for servicing and repairing the computing and other equipment.

### SUMMARY

This document generally describes computer-based technology for technologically managing the computing and auxiliary services for geographically-dispersed computer data centers both effectively and efficiently. In particular, the systems and methods described here may permit mechanical and electrical devices that serve a group of data centers to be dispatched along with the dispatching of computing processes for the group of data centers. Over time, the dispatching may change to match changes in compute loads for the data centers, changes in availability and costs for electricity from various sources at different ones of the data centers (e.g., the grid and large battery farms), and changes in atmospheric conditions local to each data center (e.g., increases or decreases in outdoor temperature). Such operations may be conducted for dedicated data centers or for multi-tenant data centers where the tenants are relatively agnostic to the location at which their data is processed.

The dispatch discussed here may involve identifying what resources are available—such as fans, pumps, chillers, and the like for cooling, and batteries, generators, and grid connections for electricity—and then dispatching such resources by sending control signals from a central dispatcher that causes those resources to operate at a level that is determined to be needed for the data centers for a time period (e.g., the next minute, 10 minutes, 30 minutes, hour, etc.).

The various components of information needed for such dispatching (both incoming data and outgoing commands) may be combined on an aggregation layer, and may be pulled by the dispatch or related system, or pushed by various components. For example, temperature readings for the outdoor air, for certain water loops, and other locations may be sent to the dispatch system on a periodic basis over the aggregation layer. Also, data about availability of and capacity of system components may be provided to the dispatch when such values change (e.g., if a chiller is taken off-line for maintenance), periodically, or upon request for an update. Such placement of the data on an aggregation layer may simplify the addition of more types of inputs, such as when a new device or system becomes available or when new external data sources (e.g., accessed via the internet) are acquired.

The control topology for such a system may thus be hierarchical in form—with a master controller at a central location that controls regional and/or local controllers, that in turn control more-local controllers or the end devices themselves. Inputs to the dispatch may be consolidated, such as on a defined aggregation layer in a system (e.g., a messaging layer in a data center operating system run at all levels)—where the inputs can be both internal to the system (e.g., sensors, operator commands, etc.) or external to the system (e.g., weather forecasts, utility demand response, etc.). Such data sources may be queue-based including priority-based (e.g., data from power monitors or other sensors in a data center) and also include scheduled pulls (e.g., from external sources like weather forecasts, utility signals, etc.). In addition, the system may coordinate multiple micro-grids at a single geographic location or across dispersed locations (where a separate geographic location would be on separate campuses, e.g., one mile or more apart and possibly thousands of miles). In addition, the system may pass data and requests to a system that schedules the compute for the various data centers, such as recommendations to cluster schedules for killing or launching IT workloads, or compute jobs, e.g., if a cooling system is failing or otherwise becoming overloaded.

Such a structure may also provide greater resilience for data centers, both locally and globally. Specifically, optimization goals may be selected that will lead to greater resilience, such as by operating below maximum levels so that fewer breakdowns occur, and also space is left open for particular data centers to take on additional compute load (and related mechanical and electrical loads), whether that is new compute for the particular location or overflow compute otherwise intended for another location. Also, optimization across locations may increase the “inventory” of compute, cooling, and electrical supply, and its diversity, so as to make it less likely that one or a small number of anomalies will cause a material disruption to the overall system. And the resilience may be balanced with other criteria like cost, e.g., by a system setting a maximum utilization level for any given location if the overall system is below a certain average global utilization (e.g., no particular location is assigned a utilization more than 20 percentage points higher than the average global utilization), and then selecting a lowest-price mix of power with that utilization rule as an input. Various other criteria may be balance via hard or softer factors (e.g., a certain parameter may be normally limited to a maximum of 80 out of 100 during dispatch, but may be allowed to rise to 90 on a “spot,” temporary basis, without requiring rebalancing or re-dispatch in the system). In the end, the systems described here may automatically and efficiently balance the criteria that an operator considers important.

The dispatch to optimize a configurable objective may also improve a system's ability to integrate with external systems. As one example, such systems may be treated similarly to other internal resources that may be dispatched, though may require external queries regarding their availability rather than already having stored data about such information. For example, energy grids (e.g., to improve system stability) and third-party dispatch providers (e.g., a cooling-specific optimizer).

In addition, such dispatch may improve a system's modularity and thus its flexibility and performance. Specifically, the dispatch discussed here can detect what resources are available, such as energy providers and users, and can dynamically adjust its controls, objectives, and constraints to such available resources. For example, particular resources may report the real-time bandwidth (e.g., in electrical or cooling power) and total bandwidth (e.g., total charge in a BESS or total run time available from a genset), in addition to other data about their operation that can be used to make an optimized dispatch decision. One or more levels of the control system

In one implementation, a computer-implemented system for dispatching devices in a computer data center is disclosed. The system comprises a plurality of energy-using devices that provide cooling and related support to computers in the computer data center, a plurality of energy-providing devices that provide power to the energy-using devices, and a dispatcher programmed to (a) identify future energy loads for the computer data center and available energy-using and energy-generating devices using data received from sources internal to the computer data center and sources external to the computer data center, (b) select particular ones of the available energy-using and energy-generating devices to serve the identified future energy loads, and (c) generate control signals to cause the selected particular ones of the available energy-using and energy-generating devices to serve the identified future energy loads. The energy-using devices may comprise pumps for cooling water, chillers, or fans, and the energy-providing devices may comprise a grid electrical connection and a large-scale battery system.

In some aspects, the data received from sources passes through an aggregation layer that consolidates information about inputs to the dispatcher. Also, the system can be arranged to receive, at the dispatcher, information characterizing aspects of multiple geographically-separated data center sites, and select particular ones of the geographically-separated data center sites to serve the identified future energy needs based on a determination by the system that the selected particular ones of the geographically-separated data center sites maximize of minimize one or more defined criteria for data center operation. The system can also be programmed to identify at one or more of the multiple computer data centers that communication with the dispatcher has been interrupted, and shift control over energy-using and energy-providing devices at the particular ones of the geographically-separated computer data center sites from global control to local control according to a predetermined control scheme. Such system may be further programmed to identify that communication with the dispatcher has resumed, provide to the dispatcher information about current status of the particular ones of the geographically-separated computer data centers, and receive, in response and from the dispatcher, information to cause continued future control of energy-providing and energy-using devices at the particular ones of the geographically-separated computer data centers.

In other aspects, the system can be is further programmed to update a learning model of energy-using devices and energy-providing devices using data about recent performance by the devices, wherein the updating stores data indicative of how particular devices perform and parameters on which the devices perform. In one aspect, the dispatcher is further programmed to dispatch computing processes performed by the computer data center, so as to better meet cooling or electrical needs of the computer data center. Also, the dispatcher can be further programmed to produce load shaping of a cooling or compute load according to a predetermined load profile. The system can also be programmed to separately schedule dispatch of computing processes for multiple different tenants in a multi-tenant computer data center.

In another implementation, a computer-implemented method for dispatching energy-using and energy-providing devices in a computer data center is disclosed. The method comprises determining a level of energy needed to be delivered to provide future continuous operation of the computer data center, selecting, from among the plurality of energy-using devices, one or more devices to provide cooling for the computer data center to meet the level of energy needed to be delivered, selecting, from among the plurality of energy-producing devices, one or more devices to provide electrical power for operating the selected one or more devices to provide cooling, and generating control information from a central dispatcher for the computer data center, to cause the selected one or more devices to provide cooling and the selected one or more devices to provide electrical power, to be operated in coordination for a determined time period.

In some aspects, the control information can be passed through an aggregation layer that consolidates information about inputs to the central dispatcher. In other aspects, the central dispatcher can be geographically remote from a plurality of geographically-separated data centers, and the control information can cause particular ones of the plurality of geographically-separated data centers to perform computer process in favor to other ones of the plurality of geographically-separated data centers based on a determination that the particular ones are more optimal for a defined criteria than are the other ones.

In other aspects, the method further comprises identifying at one or more of the multiple computer data centers that communication by the particular ones of the geographically-separated data centers with the central dispatcher has been interrupted, and shifting over energy-using and energy-providing devices at the particular ones of the geographically-separated computer data center sites from global control to local control according to a predetermined control scheme. The method can additionally comprise identifying that communication with the central dispatcher has resumed, providing to the central dispatcher information about current status of the particular ones of the geographically-separated computer data centers, and receiving, in response and from the central dispatcher, information to cause continued future control of energy-providing and energy-using devices at the particular ones of the geographically-separated computer data centers. Also, the plurality of power-supplying devices may comprise distributed energy resources (DERs), and dispatching may comprise virtually partitioning DER capacity for different uses in the computer data center.

In other aspects, the method further comprises updating a learning model of energy-using devices and energy-providing devices using data about recent performance by the devices, wherein the updating stores data indicative of how particular devices perform and parameters on which the devices perform. The method may also further comprise scheduling dispatch of computing processes performed by the computer data center, so as to better meet cooling or electrical needs of the computer data center. In some aspects, scheduling the dispatch comprises load shaping according to a predetermined load profile. Also, scheduling the dispatch may comprise separately scheduling dispatch of computing processes for multiple different tenants in a multi-tenant computer data center. And the method may further comprise identifying that the computer data center is in a degraded performance status, and dispatching energy-using devices and energy-providing devices according to a predetermined low-energy safe-mode protocol in coordination with the reboot of the computer data center.

In certain implementations, the techniques discussed here may provide a variety of possible benefits. For example, grid stability can be improved for related utilities by using peak load management, demand response, energy dispatch over longer time scales, ancillary grid services, and power factor correction in coordination with a utility that operates the grid(s) serving one or more data centers. Sustainability goals may be improved, such as by reducing carbon generation, providing 24×7 CFE maximization, lowering water usage (e.g., for cooling towers or other evaporation), lowering particulate emissions and NOx, and the like. In addition, capital expenditures may be more fine-tuned and lowered, such as by matching capacity for BESS, redundancy of systems, sizing of chillers, gensets and other equipment, and other expensive capital costs.

Systems may also be more resilient, in that BESS charging can be optimized for resiliency, resource availability may be maintained to accept new “requests” that arrive, failsafes can be employed when availability foes not match incoming demand, and standby power capacity (e.g., fueled gensets) may be made always available. Reporting from end units as part of the communications discussed here may also permit for maintenance-aware dispatch, so that a data center does not commit equipment that will require maintenance before the relevant work can be completed. The systems can also be made aware of tenant service level agreements, and be programmed to ensure that such agreements are agreed with by the system's operation. The programming can also include considerations that are “community aware” in that operating potentially loud equipment can be prevented or deprecated in the nighttime or other relevant times. Similarly, the programming can be regulation-aware, in that, for example, cumulative runtime of diesel or other devices are kept below a permitted amount.

Facility life can be maximized in concert with other optimization objectives too, such as by compressor cycling, operating below max levels, BESS charging in a “nice” manner, and balancing equipment runtimes. Physical state changes may also be tracked and adapted too, such as updating models when a tenant adds or withdraws IT equipment from a data center. Also, the systems and methods here may allow a system to make recommendations to a cluster scheduler for using or throttling CPU/GPU performance (e.g., power capping) based on power availability—and other feedback that mechanical and electrical systems can provide to a cluster scheduler to optimize relevant factors and keep the system operating at sustainable and efficient levels.

In certain implementations, the systems and techniques discussed here may provide one or more technological advantages. For example, the technological problem of coordinating many electrical and mechanical devices across many geographics so as to meet related optimization criteria (e.g., to lower operating cost while maximizing availability) is a complex, multi-factored technical problem not capable of mere manual solution. The systems and methods described here provide a technological solution that provides automated receipt of system performance data and other relevant data, automatic processing of the data against models (including learning models) of system performance to determine geographic locations for processing to occur, modes of the data processing and related processes (e.g., using electricity from the grid, a BESS, or other source) and particular devices and operating parameters for those devices (e.g., selecting which chillers in a bank of chillers to use, the chilled water temperature or other setpoint to set the chillers at, and the time to run them), and other technical solutions for the related problems. This mass coordination of machine operation is a technological solution in character.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of a computer-based system for dispatching energy-providing and energy-using devices in a system of computer data centers.

FIG. 2 is a block diagram showing hierarchical arrangement of control components for a data center control system.

FIG. 3 is a block diagram of physical devices and their interaction in a computer data center.

FIG. 4A is a flow chart showing dispatch of energy resources in a computer data center.

FIG. 4B is a flow chart showing management of cooling infrastructure in a computer data center.

FIG. 5 shows an example computer system that can be used singularly or in multiples to carry out the techniques described herein.

Like reference symbols in the various drawings indicate like elements.

### DETAILED DESCRIPTION

The following figures and related description generally describe computer-based systems and techniques for managing a computer data center in a system of multiple geographically-dispersed data centers—involving the main computing machinery that carries out the “compute” task and/or auxiliary systems that support that main compute, such as electrical supply, cooling, lighting, and control systems. In certain examples, data can be gathered across multiple data center campuses and analyzed to determine where and how to dispatch compute loads that need to be handled by the data centers, and also related mechanical and electrical loads. Such dispatch decisions can be based on decision metrics such as minimizing costs (mainly for electricity), availability of reserve power (e.g., for BESS systems or remaining fuel for gensets), ambient noise considerations around data centers, availability of adequate equipment, and ability to operate equipment at levels that will maximize availability and equipment life-span.

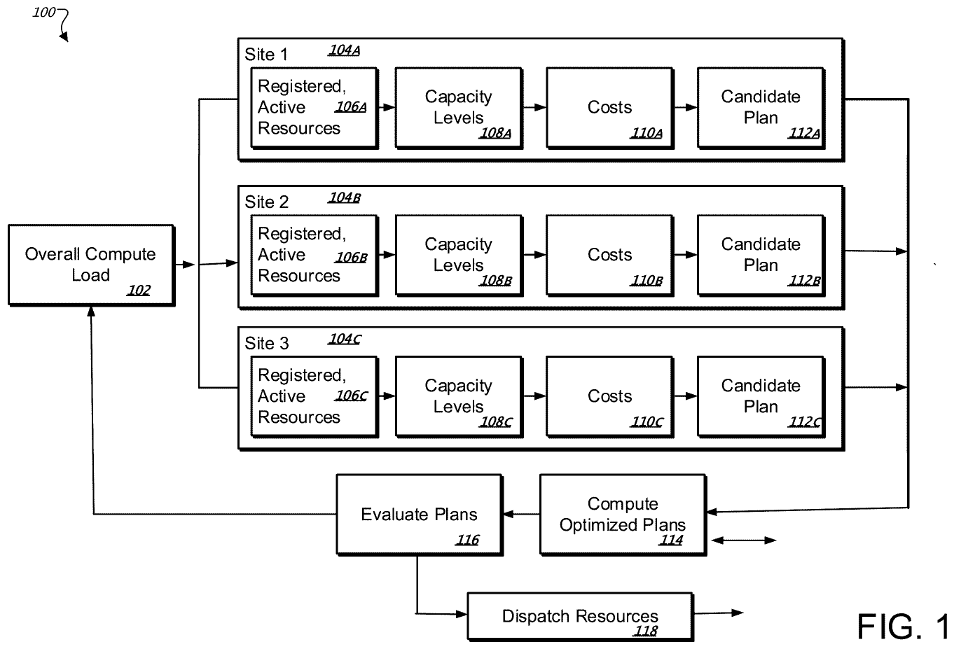

FIG. 1 is a block diagram of a computer-based system 100 for dispatching energy-providing and energy-using devices in a system of computer data centers. In general, the system 100 shows determinations that may be made with respect to three data centers 104A-C that cooperate to perform computing tasks, where the determinations are then used by a central system to dispatch all or part of the compute load to one or more of the data centers, along with corresponding operations for cooling and other auxiliary activities. The particular determinations for each site may be performed by sub-systems operating at each site and aggregated at a central controller, performed all or essentially all by the central controller, or a mix of the two.

At box 102, an overall compute load is identified. This compute load may represent an expected load for a certain future time period (e.g., several seconds, minutes, or hours) and may include assumptions about instantaneous loads (e.g., user queries, ecommerce activity from customers, etc.) that are based on load profiles from past activity and also less time-sensitive actions like training of machine learning systems, compiling of data, and various batch processes (e.g., converting a large number of videos from a first format to a second). The overall compute load 102 may also be converted from a bare compute load to a corresponding cooling and electrical load, using models that correlate compute to electrical power consumption and heat generation, and models that correlate corresponding cooling operations to electrical power consumption.

Parallel determinations are then made for each of the three sites 104A-C relating to their ability to handle all or some of the overall compute, and the terms on which they each can handle it. Referring just to the actions for Site 1 (item 104A), initially, active resources that are registered with the system or a data center operating system for the system may be identified (boxes 106A-C). For example, on the compute side, the number of CPUs, GPUs, or other devices, and the processing bandwidth for them may be identified. That level may be given a reduction (e.g., 10% or 20%) to ensure longer life for the components, and the computed amount may represent the total amount of the overall compute that Site 1 can handle. Other registered, active resources may include auxiliary components that have been connected to and registered with the system, and that are currently operable to serve the system, such as sensors, fans, chillers, fan/coil units, pumps, heat exchangers, gensets, BESSes, renewable energy sources, small fission plants, grid electrical connections, and the like. Again, this allows the system 100 to set the edge of possibilities for Site 1.

Boxes 108A-C show identification of capacity levels. On the compute side, that can include determining the amount of computing the various CPUs, GPUs, and other structures can perform. That determination may use data sheets or similar data sources for particular components and/or may use simple or complex models of the actual components installed at the site—e.g., by observing how long a certain amount of compute took to process at the site or in a sub-portion of the site in a prior operation. On the mechanical side, the capacity levels may be expressed in BTUH or tons of cooling, expressed both in terms of time units and electrical power usage. Likewise, capacity levels for electrical sources (to serve both the compute and mechanical operations) can be measured in terms of instantaneous power and power delivered over a certain time period. The system capacity for Site 1 may generally be determined to be the lowest of the compute, mechanical, and electrical capacity. A correction factor may also be applied to one or more of the capacities, such as by reducing total capacity by 20% so as to factor in risks that the system cannot operate at 100% capacity, or to help extend the life spans of devices by not running them full-out. Capacities may also be more dynamic, such as total current charge on a BESS system, and total stored fuel (translated into amount of run time and/or total electric power delivered) for a genset or bank of gensets.

At boxes 110A-C, costs associated with the various systems may be determined. Such costs may be determined for a number of criteria and a number of various scenario mixes. For example, the costs may be determined in particular ones or mixtures of simple economic cost (e.g., for genset fuel, receipt of power from a grid, etc.), carbon cost, ambient noise cost, wear-and-tear on equipment above or below a baseline cost, and other criteria that a user of the system determines to be a factor that goes into weighting the desirability of using a particular option. The various costs may be converted into a single cost metric, such as assigning a dollar value to non-monetary costs like carbon cost and wear-and-tear from over-driving machinery.

From the various prior determinations, a candidate plan (box 112A) for Site 1 may be generated, as may candidate plans for site 2 (box 112B) and site 3 (box 112C). The respective candidate plans 112A-C may be an effort to locally optimize resources for certain defined criteria (e.g., lowest cost while not exceeding capacity). Such plans may be used without change, or may be evaluated at other levels, such that, for example, a global controller may use the candidate plans or portions of the candidate plans to generate a master plan that takes into account additional, global criteria, such as determining that a currently-lowest-cost data center can take on excess load at the current time, and may thus push more load to it. An appropriate component of the system also notify a cluster scheduler of the extra availability so that the cluster scheduler can identify any jobs that were scheduled to be performed later, to be moved up in time and assigned to the currently-lowest-cost data center.

For example, for candidate plan 112A, the steps just discussed may identify that Site 1 has enough remaining charge in its BESS such that it can perform 10% of the overall compute load at a price of 50 (representing off-peak grid pricing for recharging the BESS once prices have indexed downward, plus a wear-and-tear charge for using the BESS, plus a basic electrical overhead cost). Site 1 could then take on the remaining portion of the overall compute load and have it completed in one hour at an extra cost of 70, using available grid power. The optimized plan may indicate that the use of grid power under the plan will switch prices midway through the processing, e.g., from 75 before 9 p.m. local time, to 65 after—and may indicate the percentage of the compute that would occur under each such portion of the processing.

As noted, each of these operations may be repeated for each of the three example sites (or for each of three buildings at one site, or a similar clustering of multiple facilities). Various benefits may inure in having the “local” systems at each site perform all or some of such determinations, using data from local sensors (e.g., to measure amount of remaining BESS, current ambient air temperature and humidity, etc.), from external data sources such as internet-available local weather forecasts, and from other sources. Other benefits may inure from performing all the listed determinations together for all sites at a central control system—such that the controller at each site may collect and send basic local data (e.g., BESS charge levels, current chilled water temperatures, etc.) to the central controller, but then such mass of information from all the various sites may be analyzed together.

At box 114, optimized plans are computed using data from the candidate plans. Such optimized plans may be optimized for particular locations, or may be combinatorially analyzed—i.e., by combining analysis for multiple or all sites so as to generate a globally-optimized plan, as discussed above. As previously noted, the particular location at which the actions are to occur can vary depending on the implementation.

At box 116, the plans are evaluated. As an initial matter, if a single site has capacity to perform the entire load and also has the lowest cost figure for one of its plans, that site can be dispatched to take on the entire load. When the operations here are repeated with a new compute load, such site may then be listed as unavailable for the time it takes to process the entire load, or it may identify capacity levels of zero for its components during the time of the subsequent compute. In such a case, the determination would then be as between the other two sites, where the decision may be to send all the compute to one site, the other, or a mix of the two. Also, multiple plans may be generated for each site so as to allow different concerns to be addressed. For example, as just noted, one plan may suppose that the site can take on the entire proposed compute load. Another plan may be generated, subject to a rule that no individual site can take more than 30% of any particular compute load, or cannot be more than 50% occupied by one compute load—so as to provide diversity that can lead to higher availability of the different data centers, or the ability of data centers to take over unexpected compute needs in the future.

Various rules may be employed to identify a “best” plan for the entire system 100, and may take into account cost metrics for each plan, like those discussed above. For example, weightings may be applied to factors such as cost, diversity, availability, machine wear-and-tear, and other points, and a master plan may be selected for the mixture of plans that minimizes or maximizes some combination of global metrics. Thus, for example, the system 100 may learn from the individual plans that Site 1 can take the entire load at an overall cost that is lower than the other sites. But it may then apply a limit to Site 1 taking only 70% of the load, and pick a plan for another site that has the second lowest cost and is capable of taking the other 30% of the load without surpassing imposed capacity limits. Such a decision may be considered an “optimal dispatch” for the load in that it minimizes or maximizes (or nearly does so) one or more desired metrics for the system.

In actual implementations, the global plan may be much more complex and may be reached using various technological computational mechanisms. For example, a learning system may be established for making dispatch decisions and may be trained initially on historical operating data (both data loads coming in, and the various systems'reactions in handling the loads). It may be subsequently and continuously trained by later operation of the overall system so as to better optimize decision goals like saving on electricity costs and the like.

In certain circumstances, the evaluation of plans may not be possible or may be sub-optimal based on one or more metrics. For example, it might not be possible to handle all of the compute load in a timely manner while keeping data center utilization below a certain level. In such a situation, the system 100 may provide feedback to a component like a cluster scheduler to indicate such difficulty in handling the load. The cluster scheduler may then return to its rules and programming to attempt to lessen the load, such as by smoothing the need to process non-time-critical load. The system 100 may also provide the cluster scheduler with information to assist in doing so, such as by indicating that greater capacity can be available at a later time when the ambient conditions are cooler or drier, or by indicating that cost restrictions can be avoided by time-shifting the processing. Various other mechanisms and communications may be made between a component like a cluster scheduler and the system 100 (and the cluster scheduler may be implemented as an integral part of system 100) to create a form of dialogue so that the cluster scheduler can indicate its flexibility, the system 100 can indicate benefits of being flexible, and the two can agree on the optimal path for processing the data. Where the system 100 gives such feedback to the cluster scheduler, the cluster scheduler may generate a revised compute load, and submit it again to the system 100 and the system 100 may again generate and evaluate local plans, and attempt to produce a global plan.

The optimal dispatch discussed here can be performed at a site level and also at other levels in the system, either as part of the making of an optimized plan, or after a global plan has been selected, and as part of optimizing how such plan is carried out at each site. For example, the global plan may indicate that Site 1 is to take on 30% of a future compute load. In optimizing how the site carries that out, either the global or local system may take into consideration the options available to it (e.g., in terms of register, active resources like servers, chillers, BESSes, grid connections, and the like) and may select particular components that reach a desired goal (or goals) like cost savings. Thus, at multiple hierarchical layers, plans may be made to use sites and particular equipment at those sites to carry out the compute load, mechanical load, and electrical load, in a manner that optimizing defined decision criteria.

At box 118, the resources are dispatched. Specifically, electronic commands may be generated and transmitted to sites (by a central controller that is at a location of 1 or 0 of the sites) so as to define what is expected from each such site, and the related data may also be sent by separate mechanism for processing. The commands may indicate the size and character of the compute load, the time in which it is expected to be performed, and other relevant factors to allow each site to respond to the load. A conversion may be made at a global level or by systems at each site, to convert the compute load into other relevant factors such as an expected cooling load. That cooling load may then be used as a main input parameter to decisions about what equipment to dispatch at the site, and how to dispatch it—e.g., operate a BESS from 80% charge down to 20% charge to try to get to a time at which electrical rates drop according to a rate schedule, then switch to grid power at the lower rates and re-charge the BESS at the lower rates (though perhaps after the processing is complete so as to smooth the amount of current draw from the grid). The dispatch may likewise specify certain non-compute signals directly (such as cooling levels required, BESS usage, and the like).

The dispatch may also be altered after an initial plan is developed (as is indicated by example with a separate external arrow entering and exiting the compute optimized plan action 114). For example, a particular site may have a “dynamic” arrangement with its local utility by which their computer systems communicate nearly continuously to align electric availability levels from the grid with electric demand from the site. As a simple example, perhaps the plan is to use a BESS from 80% to 20% as indicated above, but a cloud bank rolls into an area before the scheduled reduction in rates, thus making general air-conditioning demand on the utility grid fall. In such a situation, the utility may contact the system 100 and indicate that off-peak pricing may be available earlier than normally scheduled, and the master controller or a controller at the local site may amend the plan as the compute load is being processed so as to draw all remaining power from the grid rather than the BESS (e.g., if using the off-peal grid power is cheaper than using off-peak power to charge the BESS, and then to discharge the BESS).

In this manner, the system 100 can flexibly handle incoming compute loads for systems spread across multiple geographies in a location-agnostic manner. The system 100 may seek an optimal response to incoming loads such as to minimize or largely minimize operating costs of other relevant considerations. The optimization process may occur both at a level of determining how much of any compute load each site will get, and also at a level of how each site will carry out the processing (e.g., by selecting one cooling or electrical source over another).

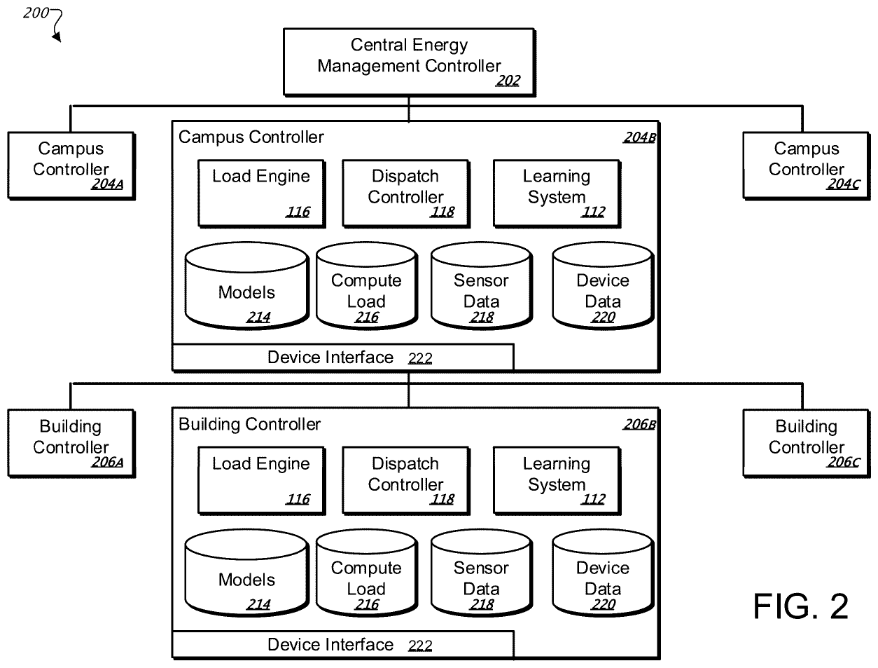

FIG. 2 is a block diagram showing hierarchical arrangement of control components for a data center control system. As described above, data centers may be cooperatively controlled, both at a single site and across multiple geographically-distributed sites across an entire country or across the world. FIG. 2 illustrates how a system 200 can use components, including the same control application or operating system operating at different hierarchical levels, to effect coordinated control and operation of a data center system at many sites.

In the figure, the system 200 is implemented as a three-level hierarchy. At the bottom level are building controllers 206A-C, which may correspond to energy management controller 110 in FIG. 1. The building controllers 206A-C each monitor and control the energy flow for a particular building on a data center campus. At the middle level are campus controllers 204A-C, which can either directly monitor and control each of multiple data center buildings at a particular geographic location (a campus), or can obtain information from and provide control instructions to, one or more building controllers 206A-C located at the particular campus. At the top of the hierarchy is a central energy management controller 202, which receives data from and provides control information to multiple different campuses. Particular components are shown for the campus controller 204B and the building controller 206B, and the central energy management controller 20 may use the same or similar components, such as a common data center operating system throughout, but may provide an different user interface and may implemented portions of the operating system or application that are more of concern for a central operator than a local operator. And each level may be able to communicate with its adjacent level or all other levels through appropriate APIs and also secure protocols that prevent third parties from listening to or interfering with the data center information gathering and control.

The building-campus interaction may occur in a number of manners and provide a number of benefits. For example, building controllers may be more local to particular end devices and may more granularly and efficiently manage them, and provide for a user interface at the particular building which is not confused by displays for other buildings. The campus system may then incorporate inputs from the various buildings, and may develop models from such data to apply to predictions made across all the buildings—though such models may recognize differences for each of the buildings, such as orientation toward the sun, types of server systems, and the like. As such, a central manager may coordinate so that load is shared among and shifted among the individual buildings as needed.

The campus-central interaction may likewise occur in a number of manners and provide a number of benefits. For example, the relevant user interfaces may again be directed to what is relevant to the particular user—even though each level may use the same application or operating system, but may employ different features of it. For example, the central system may store data across all buildings and all campuses, and may perform complex analysis from such data. It may also make certain campuses aware or capabilities at other campuses, such as to shift some compute from a geography where it is currently warm and/or day time (so electrical rates are high) to one where it is dark and/or cool (so lower rates). The system 200 via controller 202 may likewise give campuses access to data and tools that are relevant to them, while providing security so that one user's or campus'data is not shared without providing appropriate compiling or other anonymization first.

Particular example components of a controller are shown with campus controller 204B, and are repeated with building controller 206B, though different components may be activated for the different levels and at other controllers at the same level, and access to applications or data may be dependent on the level at which the system is activated (with higher levels generally having broader access) or the role of the user logged into the account (where managers have more access and technicians less).

Referring specifically to example controller 204B, the controller can rely on a number of components as part of determining the loads that its sub-system will face in a coming time period, and providing control of various devices. As an initial matter, a device interface 222 may provide for APIs and other communication with particular devices like chillers, fans, cooling towers and the like. Such devices and the controllers may be connected to a local area network when they are first installed, and the devices may declare themselves to the system and be registered with the controllers. For example, a device may provide an identifier for itself, and the controller 204B may use that identifier to obtain information online about the device, such as its cooling capacity, maintenance schedule, and other related information. Alternatively, or in addition, a device may itself provide a controller with such parameter information about the device. After such enrollment and registration, the controller 204B and all registered devices may communicate with each other through the interface 222, such as a device reporting its current operating condition parameters to the controller 204B (e.g., entering and exiting water temperatures for a chiller), and the controller sending control information to the device, such as to cause the device to operate according to different setpoints than it is currently operating. Though described as communicating with controller 204B here, the devices may more appropriately or additionally communicate with controller 206B, which may then consolidate information or route commands to/from controller 204B (as may be true with other components or operations described below).

Also within the controller 204B are several components that carry out analysis of information received from the controller 204B and various databases that the controller obtains dad from in other to carry out such analysis. As to the analysis components, a load engine 208 carries out calculations to determine the level of electric load that a data center, campus, or worldwide operation will face in the near future. For example, load engine 208 may obtain information from a public weather service about forecast temperature and humidity in an area around a particular data center for an upcoming minutes or hours, may obtain information about an expected compute load over that time period, and may determine how much heat such load will generate, and how much electricity will be required to mitigate the effect of the heat.

A dispatch controller 210 may act on the determinations made by the load engine 208. For example, if the load engine determines that a certain number of BTUH will be required for cooling over the next 30 minutes to offset heat created by racks of servers in a particular data center, the dispatch controller may (a) identify which cooling devices are available (e.g., registered and not subject to current repair or maintenance), and (b) determine how much cooling each such device can provide. For example, using dimensionless numbers for simplicity, if the need for cooling is 500, and the system has chillers whose continuous operation is 100, 200, 300, and 500, the dispatch controller could select either the fourth chiller or the second and third chillers together to run over that time period. Such a decision may depend on, for example, the relative electrical efficiency of each choice, on a desire to even out the number of hours of operation on each chiller, on an understanding that the need will fall a bit after the 30 minutes (such that the 200+300 option could be stepped down to just 300, and may thus be superior to the 500 option), on seeing data indicating that one of the chillers may soon be in need of maintenance, and other such considerations. When the dispatch controller 210 has made such determination, it can cause control signals to be transmitted out to the relevant devices over the LAN via device interface 222. Or it may send instructions to building controller 206B, which may then forward the instructions to the relevant device(s) or may use any received information to generate its own form of information to be provided to the end devices. In addition, the dispatch controller 118 may be used to cause control to be passed between different data centers, upon a determination that certain compute should be performed at such particular campus or data center (e.g., because one campus has favorable utility pricing or a greater amount of free capacity over the defined time period).

At box 212 of campus controller 204B is a learning system 212. That component is programmed to incrementally train the system 200 to more accurately predict electric and other needs. For example, after load engine 208 and dispatch controller 210 cause the system 200 to be operated in a certain manner after they obtain information about approaching weather and approaching compute needs, the learning system 212 can determine whether the system 200 accurately maintained an appropriate state of the system 200 (e.g., air temperature at the servers). If it did or if it did not, the learning system may use such variance or lack of variance to update a model of the system 200. For example, if the prediction provided too much cooling capacity over the most recent defined time period, the training of the system 200 on such new information may cause the model of the cooling and electrical system on which the load engine 208 relies to adjust away from that error, such as by lowering the amount of heat generated by each unit of compute in the model, updating the efficiency of certain cooling components, or changing the modeling of ambient temperature and humidity effect on the recommendations generated by the system 200.

The learning system 212 may operate both locally and globally. In particular, a learning system 212 in a building controller 206-C that implements a new type of power or cooling technology may learn, through actual operation and generated training data, the particular real-world reaction of that new type of technology (e.g., a new chiller). It may then provide such measured data or modeling to one or more campus controllers 204A-C, or to a central energy management controller 202. The more central controllers may then integrate the data so that it can be used by other portions of the system—e.g., it may use training data from a first data center that installed and operated a certain type or size of BESS to be available to other data centers as soon as they install the same (or operationally comparable) type or size of BESS.

Moving to the example databases used by the campus controller 204B, there is first a models database 214. It contains data that define the models just discussed, which are used to convert various inputs into a prediction of how much electric power will be needed over a certain defined time period. The compute load database 216 contains data needed to convert a particular level of compute operations to a particular level of generated heat for any facility or part of a facility (which will depend, for example, on the type of compute and on the type and number of GPUs and CPUs and other components that take part in such compute). Sensor data database 218 may include both current and historical data from various sensors, which data may be used to update the models 214. For example, the sensor data may include ambient temperature and humidity readings taken at the data center, water in/out temperatures for chillers and air handling units, air temperatures inside a data center, and other such sensor data. And device data database 220 includes information about the various energy sources and energy users, such as data that graphs the relationship between cooling provide by a chiller at different load levels, and electricity demanded by the chiller at such level(s).

As an example of hierarchical flow of information through system 200, consider a central energy management controller 202 coordinating operation across multiple different sites. For example, a single company may want to aggregate data from different locations to create better models or to help manage operations on a broader, and thus more efficient or flexible, basis. Or a company that provides system 200 to multiple different customers can operate central energy management controller 202 to aggregate data across multiple customers, and then return more powerful (and fully anonymized) aggregated data. Thus, for example, a data center in a low-humidity area may otherwise have an incomplete or unsophisticated model for high-humidity situations, but may take advantage of data from a different data center that frequently faces high humidity.

As another example, each local campus may compute its electric needs over a defined time period (e.g., minutes or several hours) and submit them to the central energy management controller 202, which may in turn compute the costs of using grid or other power in each location to deal with “local needs.” The controller 202 may determine that, for the defined time period, one of the locations has much more favorable pricing for electricity, that that location has compute capacity available, and may cause the compute to be transferred for performance at that less-expensive location. In this manner, a target goal can be met more often and more readily, by seeking that goal across multiple buildings and multiple campuses.

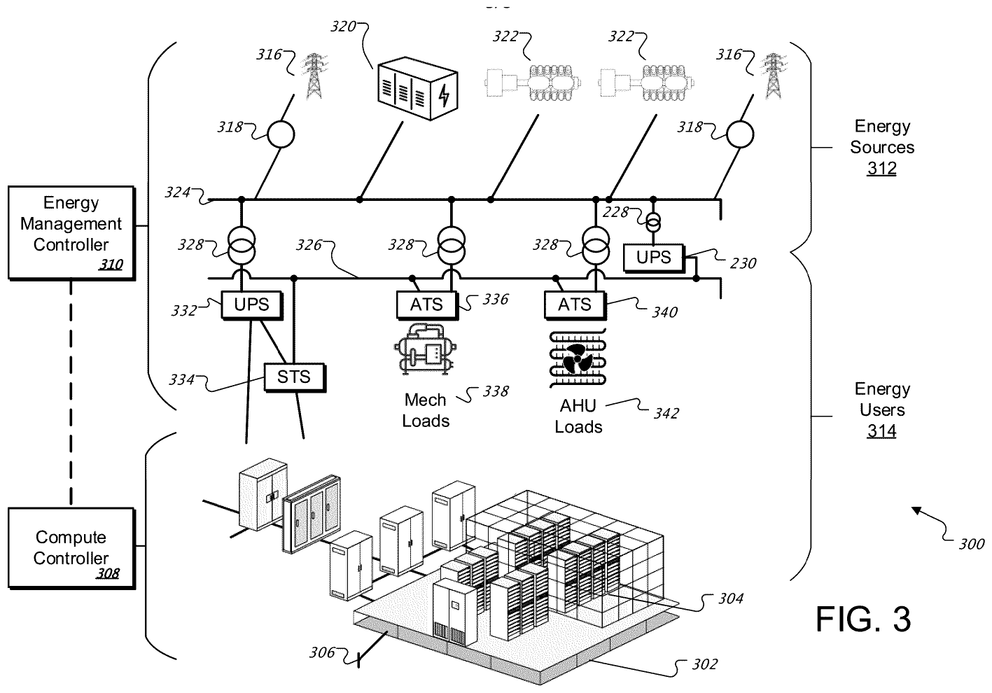

FIG. 3 is a block diagram of physical components and their interaction in a computer data center to provide power and cooling. As described above, these various components may interact to identify a future need for electrical power (including by determining a future need for cooling and other services) and to deploy the resources, as dispatchable assets, needed to meet that need, subject to certain defined goals, such as minimizing costs or carbon generation, or maximizing efficiency (e.g., running at a higher load level) or flexibility (e.g., running at a lower load level so as to leave room for changes). Relevant components (e.g., energy management controller 310) may carry out operations like those discussed above and below in terms of dispatching physical devices in a data center system to optimize one or more desired parameters.

In the figure, a system 300 is shown centered around a data center 302 facility. The data center 302 may take a variety of forms and is shown in simplified form here with its walls and roof removed, and with a number of rows of computer racks 304 inside. Each of the racks 304 may contain a number of computer servers, power supplies, networking components, and the like, needed to serve a variety of needs, such as e-commerce processing, artificial intelligence (AI) processing, generation of search results, operation of back-office operations for a business (or multiple businesses in a multi-tenant data center model), and a variety of other uses. The data center 302 may be dedicated to a single tenant or may be shared among multiple tenants, either by physically demarcating machines or physical zones for certain tenants, or sharing machines among multiple tenants (e.g., using virtual machine technologies).

A data connection 306 connects the data center 302 to the internet and other relevant networks. The connection 306 can take a variety of forms, and multiple connections of multiple different or similar types may be employed so as to provide adequate bandwidth, security, and redundancy for the data center 302. Requests for computing may arrive via the connection 306 (e.g., in-coming e-commerce orders, search queries, requests for service of web pages, etc.) and the data center 302 may process those requests in appropriate manners to generate responses that can be sent out via the connection 306 (e.g., serving of web pages and other data).

A compute controller 308 provides general management of the “compute” side of the data center 302, in terms of the processing the data center conducts as part of its main role. For example, compute controller 308 may track incoming requests over time and determine a typical compute load for the data center 302, and may communicate with other off-site systems to lessen the load or indicate that free capacity is available. As a result, compute controller may cause computing jobs to be scheduled over a time period of seconds, minutes, and hours, such as by receiving a request for training of an AI model that is estimated to take 10% of the data center 302 capacity for four hours. The compute controller 308 may then schedule that job for a future time period or periods, such as by breaking it up and processing portions of it over-night, when historical data indicates that the data center 302 is otherwise under less of a compute load, and when utility prices may be relatively favorable. The compute controller 308 may be or may implement the functionality of a cluster scheduler.

In a multi-tenant situation, compute controller 308 may track usage by different tenants for purposes of billing and to ensure that each tenant is receiving is contracted-for capacity and not more or less. Compute controller 308 may also apply various rules, such as by allowing over-use by certain tenants upon appropriate notice, and in limited circumstances. Also, in a multi-tenant environment, compute controller 308 may total up the total expected compute as a sum of all expected compute loads that each tenant sends in, or to which each tenant is entitled, with some corrective factor based on historical experience.

In addition, compute controller 308 may build models of the compute usage by the data center 302 over time, and continuously update those models so as to better schedule future compute needs. For example, the models may show a general pattern of compute activity for each day of the week across 24 hours. Such models may then be used to determine that certain types of compute load (e.g., web search or e-commerce) are likely to rise or fall a certain amount over the next n minutes or hours, and a prediction of needed data center 302 utilization for that period may be determined. The actual data for that period may subsequently be used to update and tweak the model as part of a learning process, where the model is initially and/or continuously trained on new data about compute load. Such compute model may also be muti-factored, including by incorporating indications of different types of processing, changes in the mix of processing (e.g., if a tenant has left or entered the data center 302 mix, or if the tenant needs particular types of processing such as CPUs vs. GPUs), and similar factors, so that an overall compute load can be built up from sub-models for each of the different components that produce that overall compute load. In addition, compute controller 308 may, as indicated above, schedule certain types of non-critical jobs and communicate with systems run by tenants so that the tenant systems can notify compute controller about expected compute jobs, and the two may negotiate or otherwise communicate to determine how and when the data center 302 will handle those jobs, and how much they will cost the tenant(s).

In communication with the compute controller 308 is an energy management controller 310. As the compute controller 308 monitors, models, and controls data usage by the data center 302, the energy management controller 310 monitors, models, and controls electrical power usage that is associated with the data usage (along with related functionality like cooling). A dotted line shows that the two controllers 308, 310 communicate with each other to perform such functions. As one example, the compute controller 308 (which may in common circumstances be provided by a different organization than energy management controller 310, such that the two can communicate using an agreed-upon API) may periodically or nearly continuously send to the energy management controller 310 data that indicates a compute level that the data center 302 will be seeing in the near future (coming seconds, minutes, or hours), and that energy management controller 310 can convert that compute load into an expected heat load for the components inside the data center, like the racks 304—where that heat load will need to be removed. The compute controller 108 may alternatively determine the heat load (which may be expressed as a profile over time, regardless of what component determines it) and send that to energy management controller 110.

Energy management controller 310 may make determinations about what components to dispatch, at what level to operate them, and when to operate them, based on one or more goals, which may include minimizing energy costs, minimizing carbon footprint, minimizing other environmental effects such as external noise generation overall or at certain times of the day, maximizing data center availability, and maximizing the life span of data center components. Minimizing cost may involve shifting operations to off-peak times when energy costs are lower (e.g., at night, for grid costs), such as by delaying compute jobs that can be delayed, using a BESS or genset to provide power during peak times, shifting compute load between data centers, or other techniques. Minimizing cost and carbon or other environmental effects may also involve operating the data center more efficiently, such as by operating components in a “sweet spot” of their power curve, which might be in the middle of their operating capacity. For example, if a data center has multiple chillers rated at 100 (a dimensionless number here for clarity) and has a projected need of 200, it may operate three chillers at 67 each (more efficiently) rather than two at 100 each (less efficiently). The operation of components away from their maximum load can also extend their lifespan and increase their availability, and thus indirectly decrease costs also.

As described here, the energy management controller 310 may be programmed to take into account each of these concerns, weight them appropriately (e.g., by converting energy costs, repair/replacement costs, and downtime costs to a common value, and minimizing that value), and determine an optimal operating path for a data center 302. Each time a data center 302 makes such operating decisions, it may also gather data on its actual performance compared to its expected performance, and may provide that data to a machine learning system as training data for updating a model that is used for making the determinations—and such models may be shared between and among data centers in different geographic locations. In this way, then, the system may continuously improve. The particular type of machine learning to be used, the data to be collected, and the manner in which the data is processed, may vary based on the particular application.

As part of that processing, the energy management controller 310 monitors and controls a number of components or devices that are shown schematically here to a “North” side of the data center 302, though in actual implementation, they would be located where physical practicalities dictate, e.g., to lessen the need for complicated piping, to permit access to the components (e.g., perhaps with heavy equipment) and to other parts of the data center, and by other considerations. As shown here, the components generally fall into two groups: energy sources 312 and energy users 314.

The energy sources 312 may generate electricity initially and/or may store and later provide electricity generated by another source. Shown here, there are two distinct grid sources 316, whereby a data center may negotiate to have electricity provided by two different utilities, so as to improve capacity, cost, and reliability. Each grid source 316 is shown connected to a medium voltage (MV) electrical bus 324 via a meter 318 by which electrical use by the data center 302 from the respective grid can be measured for, e.g., billing purposes. The meter 318 or an area near it may also define the relative responsibilities of the utility and the data center 302 operator for maintaining and repairing equipment in the system 300. The MV bus 324 may in turn be connected to a low voltage (LV) bus 326 via respective transformer 328. The buses 324, 326 may be fully or partially parallel to each other, and as needed, particular components may connect to the MV bus 324 rather than the LV bus 326 or vice-versa, depending on the implementation and component needs.

Another source is a group of large battery banks 320, e.g., equal to or greater than 1 MWH each, or total, and may take the form commonly known as a battery energy storage system (BESS), which includes the battery cells and associated management and control resources. The banks 320 may use a variety of chemistries, and may be sized to operate the data center 302 for a certain minimum necessary time period at a typical load, such as 30-60 minutes or one or several or 24 hours. As described more fully below, the banks 320 may be used to provide power during limited time periods when power is not available from larger sources such as the grid, to provide additional power above that is available from other sources, to allow for smooth shutdown of the components in the data center 302 under certain emergency conditions, to load shift by charging the banks 320 during the night and discharging them during the day, and other similar uses.

The other energy sources are gensets 322, in the form of natural gas or other-powered engines powering generators, again connected to the MV bus 324. Other energy sources may also be provided, such as small-scale fusion, water circulating through geothermal loops, wind generators, piezoelectric solar, hydrogen-cell generation, and the like. While such sources will generally be operated by the operator of the data center 302 or a separate utility, they may also be operated by a dedicated third party, such as a syndicate that develops power sources to be served mainly or solely to a small group of data centers under contract, such that the syndicate would not be a full-blown utility.

The energy users 314 include the various main components that require electrical power as part of the operation of data center 302. For example, a UPS (uninterruptible power supply) 332 and STS (static transfer switch) 334 may connect the LV bus 326 to the servers 304 and other electrical components that are part of the data processing for the data center 302. The STS 334 may normally carry power from the bus 326 while the UPS 332 charges from the bus 326, and when there is no power from the bus 326, the UPS 332 may automatically and quickly activate, and the STS 334 may simultaneously switch so that the compute infrastructure of the data center 302 is provided from the UPS 332. Such functionality may also be incorporated with a BESS so that, depending on the situation, the BESS may quickly switch upon indication of an interruption to provide uninterrupted supply, and in non-emergency situations can provide a scheduled switch so as to provide power that is desired (e.g., to permit load shifting) but not required in the manner UPS power would be.

Other energy users 314 include mechanical loads 338 which are connected to both buses via an ATS (automatic transfer switch) 336. The mechanical loads 338 may include, for example, chillers, cooling towers, and related pumps. Further down the cooling system are AHU loads 342 also connected by an ATS 340. The AHU loads may include fans and other pumps that circulate warmed air and cooling water through coils to effect heat transfer out of the data center 302. The cooling water may circulate into the data center 302 building to the AHU loads 342, may gain heat there, and may then circulate outside the main building and through chillers or cooling towers as part of the mech loads 338.

Finally, a separate transformer 328 and UPS 330 are provided to power the LV bus 336. As noted, such functionality may be stand-alone as shown, or may be integrated with other functions related to delivery of stored electrical energy, such that the BESS may be used in certain implementations to provide such back-up power. The transformer 328 and UPS 330 here may pick up loads otherwise served by other branches should their connections (e.g., their respective transfer switches) fail or otherwise lose primary power.

In operation, energy management controller 310 may take in information from a variety of sources to determine how much cooling will be needed for the data center 302 in the near future, and then how much electrical power will be required to achieve that cooling (and also the electric power needed to perform the compute operations that create the heat that requires the cooling). The sources include, for example, information that allows the level of compute to be converted to an expected level of heat generation, current and future ambient temperature and humidity for the area around the data center 302 for the relevant time period, information about the efficiency and operability of particular energy sources 312 and energy users 314, and models that relate such other variables to relevant needs for electric power. The information about the operability of particular energy sources may include information about whether certain devices are currently on-line or off-line, e.g., for maintenance or repair. For example, a chiller manufacturer may provide, in memory shipped with the chiller or at an on-line resource accessible over the internet, an indication of electrical power required to operate the chiller at different tonnage levels, and the system can access such information in determining how much electricity will be required to provide n tons of cooling for t time period under certain ambient air conditions. (As noted elsewhere, the system may also learn the operating parameters of a particular chiller over time, and may supplement or replace the manufacturer data with real, observed data.)

The energy management controller 310 may use such information to determine how much cooling and electrical power will be needed over a defined future time period, and may take actions to make such cooling and power available. For example, the energy management controller 310 may provide information to a related computer operated by a utility 316 to indicate future needs for electrical power and/or may consult data about the rate agreement the data center 302 has with the utility 306, to determine whether to use power from the particular grid during the defined period (and how much power to use). The energy management controller 310 may check with one or more of the energy users 314 to confirm that it is available for operation, and may consult data on each such device's capacity levels (e.g., in BTUH, and an associated electric usage at that design level).

Energy management controller 310 may also be programmed so as to make the data center 302 an active grid participant. For example, the energy management controller 310 may dynamically negotiate with one or more grids for electric pricing for upcoming periods (seconds, minutes, or hours), such that each grid can look at its current capacity and provide a lower bid if its capacity is relatively high—and where the parties can agree to the delivery of a certain amount of electric power for a certain price. The energy management controller 310 can also send a utility information about its anticipated future needs for electric power, so as to enable the utility to better manage its system, such as by maintaining certain turbines and generators in operation if the data center 302 indicates that it will have a high power need in the near future. Such information about needs and availability may run in both directions (from energy management controller 310 to utility, and vice-versa) and occur repeatedly, so that the two entities are constantly updating each other on needs and supplies. As one example, energy management controller 310 may have an indication that, by a rate agreement, the cost of power will fall in 60 minutes. But it may have a need to perform some level of compute sooner, and thus may send the utility a request to obtain power at the reduced rate starting an hour early—a request that the utility may satisfy if its systems tell it that it will likely have excess capacity over the next hour. Information flow and power flow may also be reversed, in that the utility may request information about power that the data center 302 might be able to provide to the grid, such as by turning on certain gensets or depleting certain battery banks.

Energy management controller 310 may perform “load shaping,” such as controlling when compute is to be performed (where some of the compute is not time-sensitive) or delaying the onset of cooling or other services. As such, the energy management system 310 may prevent the load from exceeding a determined maximum, while maintaining the load near the maximum—i.e., to flatten the load overall. Such load shaping may also have discontinuities nears changes in pricing or other goals, such that load may be increased step-wise at night after rates fall, or may be decreased or otherwise altered at night (e.g., operate components away from a populated area) if ambient noise around a data center is a consideration. Such load shaping may also occur even if the data center operator does not own or otherwise control the load.

For example, an interface may be provided between the energy management controller 310 for a data center and systems operated by one or more tenants (e.g., in a cloud, multi-tenant operation) whose compute is handled by the data center. The interface may institute a dialogue by which the energy management controller 310 offers lower compute pricing if the tenant allows a certain amount of their compute load to be delayed, or an auction with multiple tenants. The energy management controller 310 may initially inquire of the tenant about its flexibility—e.g., to indicate how much of its anticipated needs are not time-sensitive and how long they may be delayed. If such tenant information meets the load shaping needs of the energy management controller 310, the energy management controller 310 may offer a certain discount and the tenant may respond by accepting or rejecting the discount. Such communication may occur automatically (and quickly) between the data center and tenant systems, and may occur many times per hour or day.

Such load shaping for power purposes may also be provided as an adjunct to normal load shaping that the data center 302 may perform with its tenants, that is directed to making sure the compute capacity is not suddenly overwhelmed by near-simultaneous requests from multiple tenants. In this manner, energy management controller 310 may have successive communications with a utility and with its tenants over a short period of time (seconds or minutes) to determine both the utilities' flexibilities and price-sensitivity to delivering power at certain times, and its tenants' flexibilities and price-sensitivities about having compute performed during certain times, so as to shape a compute curve and power curve cooperatively in a manner that minimizes or maximizes a desired goal, such as electrical spend as compared to compute revenue.

Energy management controller 310 can also communicate with one or more grids 316 about power that the data center 302 could provide to the grids (rather than take from the grids). For example, data center 302 may have control over a BESS, genset, or renewable energy source (e.g. wind or solar or geothermal), where the source has the ability to provide more power than the data center 302 will currently need—either for its expected near-future needs or if the data center 302 delays certain compute projects and thus lowers its own expected power needs. In such a situation, the data center 302 may communicate with one or more grids, indicating the timing and amount of power that it might be able to make available to them. The grid(s) may then each indicate whether they have a need for such power. Thus, for example, data center 302 may find that it has fewer compute jobs in the afternoon, when cooling loads for customers of a grid are at their maximum, and data center 302 may then “sell” power back to the grid 316, e.g., to offset what it would otherwise owe to the grid. Such a process may also be instituted by a grid 316, such as the grid 316 recognizing that it will have a defined “down time” for a portion of its generating structure due to planned maintenance, such that the grid may schedule a time and amount of power that it will receive from the data center 302, which may in turn charge its BESS to deliver such power at the relevant time, or prepare to power up one or more gensets to provide the power.

These dialogues may be fully automatic (e.g., with the energy management controller 310 automatically determining its future needs and either consulting a rate schedule or performing an ad hoc auction or negotiation over rates) or partially automatic (e.g., with a person operating the energy management controller receiving a recommendation from the system, and then indicating whether a proposed transaction with the grid should occur). In this manner, the data center 302 operator may serve as a cooperative partner with the grid operator even though they are two different corporate organizations with their own needs and interests. More broadly, a data center may periodically (e.g., every minute) send a notification to its utilities about whether it is undersubscribed, evenly subscribed, or oversubscribed (or could break the levels into n different levels of severity rather than the three just mentioned), and the utilities can thus be kept up-to-date on whether an inquiry from them to receive power from the data center would be likely to be positively or negatively received.

The system 300 shown here may also allow more modular deployment and management of data center 302 components. For example, particular energy users may be manufactured as plug-and-play modules that can be added to a system, with valves then opened, and the added energy user immediately providing cooling or other services. That module may then be disconnected and added at another site in a similar manner. Or piping stubs and electrical circuits may be built initially with isolation valves/switches for n multiple taps along a piping or electric circuit. The data center 302 may initially become operational with only 1 of n devices in operation, and as computer servers are added inside the data center 302 building, modular devices can be added in coordination (and matching capacity to the amount of compute load that has been added), one-by-one until all the taps are taken and the system is at full operation. Where previously-defined interfaces (e.g., for data connections, piping connections, and electrical connections) for connecting equipment is followed, needed on-site labor may also be substantially reduced.

The system 300 may also be readily operated at different levels of capacity based on decisions made by energy management controller 310. For example, certain system components may have high reliability and/or high efficiency when operated at 70% of capacity (or below), so that energy management controller 310 can seek to stay at or near 70% during most operation. However, if a compute load arrives that needs to be performed quickly, energy management controller 310 can determine how much of the compute load can be handled per minute while running the energy users 314 at perhaps 90% or 100% of capacity, and can achieve the processing with a short period of full-speed operation. Or if 100% operation is needed to meet the load, energy management controller 310 can operate the cooling components at 80-90% but run them for a longer time period, so that temperatures might rise slightly since the compute load exceeds the cooling load for a time period (perhaps several minutes), but then the cooling can exceed the heat load from the compute for a time, and bring the system 100 back into balance.

Similar considerations may come into play for the system to maintain steady operation during an afternoon period that is particularly warm. There, energy management controller 310 may determine from publicly available forecast information that extreme heat will last 3 hours, and then the ambient temperature will drop because of an arriving cold front. Energy management controller 310 may thus cause the energy users 314 that perform cooling to operate at high levels for the three hours (and may draw down the charge on battery banks 320), knowing that the over-sized demand will be over in about three hours.

Energy management controller 310 may consider the various components that it controls as being fairly generic dispatchable assets. It may be programmed to understand, from a model, their effect on electrical supply available on the buses or their effect on cooling water available in a chilled water loop, without having to be concerned with further details of their internal operation. In such a situation, the controller, in determining which devices to send commands for operation, may look just to the device parameters that matter to its computations, and select particular devices and operational variables for those devices—and then send commands to achieve such ends in a basic dispatching model.

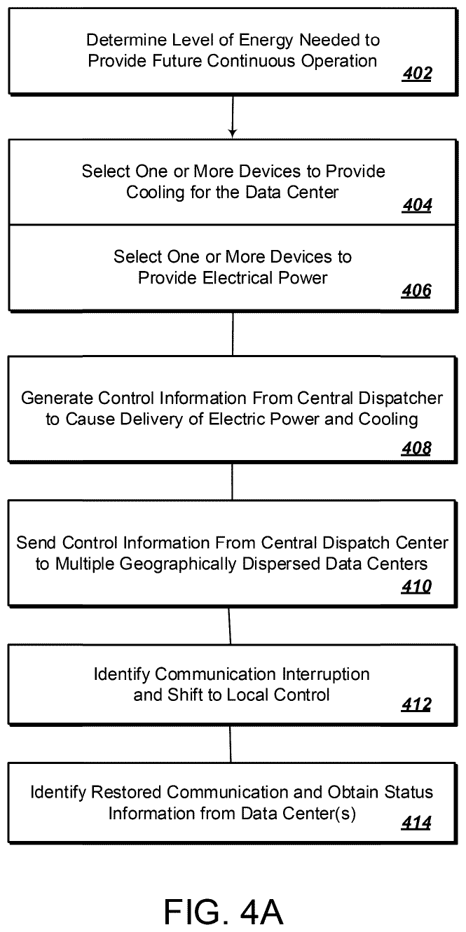

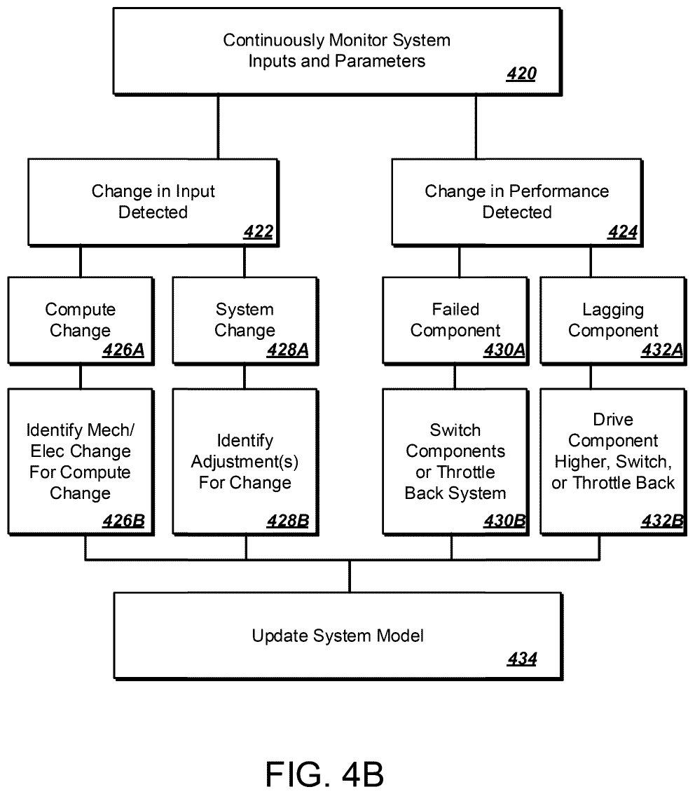

FIG. 4A is a flow chart showing dispatch of energy resources in a computer data center. In general, the process involves determining the mechanical and electrical loads that are implicated by an expected data processing load, determining a best combination of resources to handle those loads (where “best” can based on a combination of criteria, such as cost, carbon footprint, and other such factors), and dispatching the compute load and mechanical/electrical reaction to the sub-systems and devices determined to be best. The optimization can occur at multiple levels, including with determining the best computing, electrical, and mechanical components to deploy in any particular data center, and at a higher level, with determining which data centers to carry out which parts of the processing.

The process begins at box 402, where a level of energy needed to carry out future processing is determined. Such determination may start by one or more cluster schedulers determining what level of data processing will need to be performed. The level of processing may then be converted to a level of energy that has multiple components. First, the type of processing (e.g., whether performed largely by a CPU or GPU) and the actions associated with the processing (e.g., how much storage or network activity will accompany the processing) can be converted in various manners to an expected heat load to be generated by such operations. Such determination may be done both at sub-system, building, campus, and global levels, as is appropriate.

At box 404, one or more devices to provide cooling in a data center is selected, and nearly simultaneously, at box 406, one or more devices to provide electrical power is selected. The cooling selection may be made to cover (a) the level of heat that was determined to be expected at box 402, and (b) one or more criteria about which devices are a best selection to provide that cooling in a particular situation. The latter may involve determining which devices are available (e.g., registered with a data center operating system, and not currently or soon-to-be under maintenance or repair) and the benefits of using each (where benefits can be multi-factored and include factors such as cost, flexibility, etc.). Box 406 may trail box 404 in some circumstances, in that power for providing cooling may necessarily trail first determining how the cooling will be provided.

At box 408, control information may be generated from a central dispatcher to cause delivery of the cooling and electric power to occur, in coordination with one or more data centers doing the computer processing that creates such needs. And at box 410, the control information may be sent to various different facilities across various geographies (e.g., data center facilities that are separated by miles, and potentially thousands of miles). As part of that process, the central dispatcher may make determinations about which data center, from among multiple different candidate data centers, is a best data center or data centers to carry out the operations. As discussed above (e.g., FIG. 1) and below, such determination by the central dispatcher may be performed entirely by the central dispatcher using data received from each of multiple data centers, may be performed by each data center performing selections and submitting one or more candidate plans to the central dispatcher, or by other mechanisms.

The generated control information from a central dispatcher may be general, in that the central dispatcher may simply tell a data center to be prepared for n tons of cooling during a certain time period or a similar goal. In such a situation, the local controller may then convert those general instructions into more specific instructions, e.g., instructions to one or more chillers to begin operating sufficiently in advance so they can provide timely cooling, and to operate at certain levels (which can change over the time that the processing occurs). The instructions from the central dispatcher may also be more granular and take on more of the role from the local controller, such as by identifying which local resources to deploy and how to deploy them. For example, the central dispatcher's master plan may hinge on cooperative action between different data centers, with a goal of maintaining future flexibility and thus with concerns that may not be known to individual data centers. For example, a central dispatcher may understand that high variability in future time-sensitive processing needs is expected, and may thus want to hold capacity available at multiple data centers over-and-above what those data centers might otherwise hold. As such, the central dispatcher could instruct a local data center to operate its chillers at a maximum of 70% rather than 80%, but may then allow the local data center to determine how many chillers and which chillers to use to meet that goal (e.g., where the current or future operating state of each chiller may be known to the local controller but not the global controller). In other examples, the local dispatcher or the global dispatcher may take on operations otherwise handled by the other.

In certain implementations, the respective level of control may be divided so as to allow for data centers that are unaffiliated from each other (e.g., operated by different corporate entities) to process data from a central dispatcher, and to obtain revenue for such processing. With appropriate encryption of other privacy protections then, an organization may typically perform its own processing using its data center, but in times of lower demand (e.g., non-Christmas season for a retail company), the organization may make its excess bandwidth available under negotiated terms with a third party. Multiple such organizations may send data to the third-party indicating the amount of processing they have available during a defined future time period, and a price at which they are willing to perform the processing (where the price may be negotiated in advance and be part of an electronic price sheet that is available to all parties). The third-party may in turn take in demands for processing from other parties, and may use recent communications from the various organizations to choose which organizations to dispatch the processing too. The central organization may have some visibility into the mechanical and cooling capabilities of the various data centers so that it can better determine the capacity that each data center has. But the visibility may be limited, so that the organization can maintain secrecy over details about its operation.

At this point, the process may loop back to box 402 periodically or on the occurrence of a defined event, such as the arrival of a new batch of needed processing, a failure of a device or system that substantial degrades the performance of a part of the system, or other material change in events. The determinations used for dispatch may be updated and/or determined afresh using new information. For example, if the dispatcher has already committed certain data centers to certain processing, the system may leave such commitments in place, and may make determinations for new compute loads with those prior commitments applied as initial baselines—e.g., a data center that has a nominal capacity of X will be deemed to have a capacity of X-Y, where Y is the amount is committed already to handle.

At box 412, the system is operating nominally and well, when a disruption in communication occurs. For example, a local data center may stop receiving periodic and expected communications from a global controller, or vice-versa. When such an event occurs, the local controller may assert local control, and continue to operate consistent with its most recent communication from the global controller, in a form of autonomous mode. That may involve operating all devices at a steady state, operating devices at a variable level but in a way to continue to meet certain defined variable such as a chilled water temperature, or allowing additional variability, such as powering down certain devices after currently scheduled compute is completed, and additional cooling or electricity is no longer needed—at least as defined from the most recent global communication. During this time, the respective data centers can operate at a reduced, or safe, status that is generally at or below a utilization level that they would otherwise operate if they were getting updated instructions from a global controller, and possibly also taking on addition compute loads.

At box 414, the restoration of communication is identified and the global controller obtains status information from each of the local data centers. For example, the data centers may report to the global controller how much of their assigned processing has been performed, and relevant status updates for mechanical and electrical devices, such as charge remaining in a BESS, fuel remaining for a genset or gensets, time until maintenance for a chiller or set of server racks, and the like.

The process here, as with other processes described herein, will generally be interactive, in that its steps can be repeated as new computing loads arrive and/or as the assumed computing loads change by appreciable amounts. Recomputation can also occur if a sub-system fails and certain computing, mechanical, or electrical operations need to be shifted to another sub-system or another data center. In short, the process is repetitive and generally continuous, so as to match and meet the repetitive and generally continuous flow of changes and new data to be processed into the system.

In this manner, then, processes may interoperate with one or more cluster schedulers or similar systems to determine where data processing will be scheduled, as a function of available compute, mechanical, and electrical bandwidth, and a function of other parameters of operating at one location versus another, such as electrical costs over the period of the processing, operating costs of equipment, capacities for cooling and electrical supply, and other relevant factors.

FIG. 4B is a flow chart showing management of cooling infrastructure in a computer data center. In general, the shown process involves a data center OS reacting to changes experienced by the data center, in terms of adjusting mechanical and electrical resources in response to a variety of inside and outside influences on the data center operations. Those changes may come in a variety of forms, and an OS or other part of the overall system may continually listen, perhaps on a dedicated communication channel, for devices or sub-systems reporting new information. The OS may then change how currently-operating components are operating, or may add or remove components from operating in the system, so as to offset or respond to recently-received changes in the system operation.

The process begins at box 420, where system inputs and other parameters are continuously monitored. In particular, a data center control system may be instrumented to collect relevant information on periodic, frequent schedules (e.g., every second or minute). Alternatively, or in addition, the system may receive alerts when anomalies occur, such as by a sensor reporting an out-of-range value (e.g., high temperature or low BESS charge) even if it was not the time for reporting the value normally. Any appropriate change may result in the steady state operation of the data center changing, and could require a corresponding change in how the data center is operated by a data center OS like that shown above.

The sensed system changes can take multiple forms, which may affect how the OS is programmed to respond. At box 422, the detected change is a change in an input, while at box 424, the change is a change in detection of the system performance, apart from changes in inputs. The former may take a variety of forms, such as receiving a message that the level of compute in a data center will change in the near future (and thus, e.g., the electrical needs of the computers will increase, and the temperature will increase unless countering measures are taken), receiving an indication from a temperature sensor that out door temperatures have increase or receiving an indication that a temperature forecast has changed, identifying from an internal or external database that utility rates from a utility provider have changed or will change during a future time of interest for the control system, and other typical or atypical changes in the system inputs. The latter may also take a variety of forms, including identifying (e.g., via performance monitor 118 in FIG. 1) that a particular component in a system is not performing as predicted by a model that has been used to determine future mechanical and electrical needs for a data center, such as determining that a new computing platform is generating more heat per unit of computing that it was expected to, or determining that a chiller is providing fewer BTUs of cooling for each input Watt of electricity than it previously was.

As to the change of an input (box 422), such changes can be identified as compute changes (box 426A) or system changes (box 428A), and may be addressed differently depending on such identification. A compute change (box 426A) involves changes of actual or expected compute load on a system. For example, using dimensionless numbers for simplicity, a normal steady-state for a particular data center may be 100, with jobs that need to be performed immediately such as search queries or streaming video, jobs that can be delayed slightly and vary over time but by a small and generally predictable amount such as email and other asynchronous communications, and related overhead for such compute load. A monitor may identify that such activity has increased by almost 20, is fairly steady, and is trending upward—above what the model had predicted, but in a shape consistent with other daily activity for such load. Or a sub-system may submit a request for additional compute at a level of 20 that is expected take an hour to perform. In either case, this compute change will need to be addressed by the mechanical and electrical systems. Alternatively, a system change (box 428A) may be any sensed change that is not a compute change, and may include a change in ambient temperature that does not match an expected change over time that the system is currently operating under. Or it may be an indication that a BESS is low, or that a piece of cooling equipment has failed.

In response to identifying any such changes, the system may recompute and rebalance the mechanical and electrical systems to counter the changes, as shown at Boxes 426B and 428B. For example, at Box 426B, the process determines a level of mechanical load (e.g., heat) that will be generated by the new compute load (which could be higher or lower than the load the system had previously assumed for the same time period), and also a level of electrical load from the compute load (to run the computers) and the new mechanical load (to run the other equipment). At Box 428B, the system identifies adjustments to be made to address the sensed change in the system, such as looking to a model that correlates, inter alia and in the case of a change in ambient temperature, ambient weather conditions and compute loads to heat loads generated in the data center. The system may then send commands to particular devices or sub-systems so as to implement those changes. And although not shown, the process may loop back to the beginning to continue obtaining sensed measurements for the system operation, and then make future changes periodically and/or in response to particular notifications from the system.

Such conversions and computations as indicated by boxes 426B and 428B may initially be performed using manufacturer data for devices or testing on individual devices (e.g., putting a fully-equipped motherboard in an enclosed test environment, feeding it controlled compute loads, and measuring the heat it generates at particular loads), and then multiplying such individual computations by the number of devices expected to be deployed. Such a simplified approach or other initial approach may then be modified and enhanced over time by training a learning system with actual data measured over time from the data center or particular defined parts of the data center as measured.

In this manner, components of a data center OS may operate with registered resources, such as computing, cooling, and electrical providing devices. The data center OS may be automatically adaptable in that it may respond to changes relevant inputs in the data center, and readily determine changes in controlled devices that will be needed to keep the data center operating stably and directed to desired goals, such as minimizing electrical costs, total operating costs, or carbon generation.

Regarding changes in performance being detected (box 424), such changes could be a complete failure of a component like a chiller (box 430A) or a lagging component (432A)—a component that is still operating but not operating at a level that is expected. For a failed component (box 430A), the process may switch to another version of that type of component that can take on the load, or if that is not available, may throttle back the system (box 430B) so that whatever components are operating are able to keep up. For a lagging component (box 432A), the system can try to drive the component higher(box 432B) (e.g., set a lower chilled water cooling temperature for a chiller) or throttle back the system such as by spreading out the time that it takes to perform a scheduled compute, and thus generate less heat in the near-term.

Finally, at box 434, a system model may be updated. Specifically, data recovered from the abnormal operation of the system and from reacting to that operation may be added as training data to a learning system. For example, for a lagging chiller, the model may be updated to lower the amount of cooling the chiller can provide under the particular operating conditions. In addition, a maintenance alert may be generated for a human operating from such monitoring, so that they perform relevant testing of the chiller to see if the lagging is expected or atypical, and requiring of a repair (e.g., adding refrigerant).

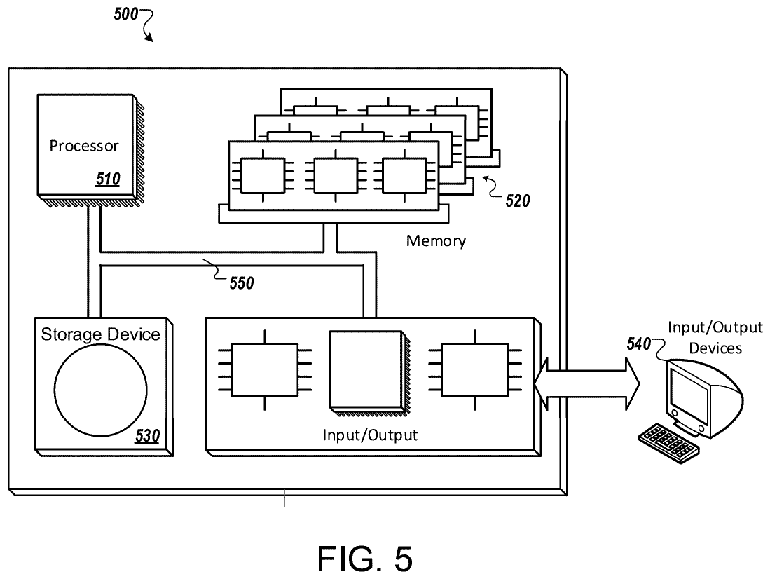

FIG. 5 is a schematic diagram of a computer system 500. The system 500 can be used to carry out the operations described in association with any of the computer-implemented methods described previously, according to one implementation. The system 500 is intended to include various forms of digital computers, such as laptops, desktops, workstations, personal digital assistants, servers, blade servers, mainframes, and other appropriate computers. The system 500 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output devices, such as a wireless transmitter or USB connector that may be inserted into a USB port of another computing device.

The system 500 includes a processor 510, a memory 520, a storage device 530, and an input/output device 540. Each of the devices 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 400. In one implementation, the storage device 530 is a computer-readable medium. In various different implementations, the storage device 530 may be a floppy disk device, a hard disk device, an optical disk device, or a tape device.

The input/output device 540 provides input/output operations for the system 400. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, device, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end device, such as a data server, or that includes a middleware device, such as an application server or an Internet server, or that includes a front-end device, such as a client computer having a graphical user interface or an Internet browser, or any combination of them. The devices of the system can be connected by any form or medium of digital data communication such as a communication network.

Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system devices in the implementations described above should not be understood as requiring such separation in all implementations, and it should be understood that the described program devices and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented system for dispatching devices in a computer data center, the system comprising:
a plurality of energy-using devices that provide cooling and related support to computers in the computer data center;
a plurality of energy-providing devices that provide power to the energy-using devices; and
a dispatcher programmed to
(a) identify future energy loads for the computer data center and available energy-using and energy-generating devices using data received from sources internal to the computer data center and sources external to the computer data center,
(b) select particular ones of the available energy-using and energy-generating devices to serve the identified future energy loads, and
(c) generate control signals to cause the selected particular ones of the available energy-using and energy-generating devices to serve the identified future energy loads.

2. The computer-implemented system of claim 1, wherein:
the energy-using devices comprise pumps for cooling water, chillers, or fans, and
the energy-providing devices comprise a grid electrical connection and a large-scale battery system.

3. The computer-implemented system of claim 1, wherein the data received from sources passes through an aggregation layer that consolidates information about inputs to the dispatcher.

4. The computer-implemented system of claim 1, wherein the system is arranged to:
receive, at the dispatcher, information characterizing aspects of multiple geographically-separated data center sites, and
select particular ones of the geographically-separated data center sites to serve the identified future energy needs based on a determination by the system that the selected particular ones of the geographically-separated data center sites maximize of minimize one or more defined criteria for data center operation.

5. The computer-implemented system of claim 4, wherein the system is further programmed to:
identify at one or more of the multiple computer data centers that communication with the dispatcher has been interrupted, and
shift control over energy-using and energy-providing devices at the particular ones of the geographically-separated computer data center sites from global control to local control according to a predetermined control scheme.

6. The computer-implemented system of claim 5, wherein the system is further programmed to:
identify that communication with the dispatcher has resumed,
provide to the dispatcher information about current status of the particular ones of the geographically-separated computer data centers, and
receive, in response and from the dispatcher, information to cause continued future control of energy-providing and energy-using devices at the particular ones of the geographically-separated computer data centers.

7. The computer-implemented system of claim 1, wherein the system is further programmed to update a learning model of energy-using devices and energy-providing devices using data about recent performance by the devices, wherein the updating stores data indicative of how particular devices perform and parameters on which the devices perform.

8. The computer-implemented system of claim 1, wherein the dispatcher is further programmed to dispatch computing processes performed by the computer data center, so as to better meet cooling or electrical needs of the computer data center.

9. The computer-implemented method of claim 8, wherein the dispatcher is further programmed to produce load shaping of a cooling or compute load according to a predetermined load profile.

10. The computer-implemented system of claim 9, wherein the system is programmed to separately schedule dispatch of computing processes for multiple different tenants in a multi-tenant computer data center.

11. A computer-implemented method for dispatching energy-using and energy-providing devices in a computer data center, the method comprising:
determining a level of energy needed to be delivered to provide future continuous operation of the computer data center;
selecting, from among the plurality of energy-using devices, one or more devices to provide cooling for the computer data center to meet the level of energy needed to be delivered;
selecting, from among the plurality of energy-producing devices, one or more devices to provide electrical power for operating the selected one or more devices to provide cooling; and
generating control information from a central dispatcher for the computer data center, to cause the selected one or more devices to provide cooling and the selected one or more devices to provide electrical power, to be operated in coordination for a determined time period.

12. The computer-implemented method of claim 11, wherein the control information is passed through an aggregation layer that consolidates information about inputs to the central dispatcher.

13. The computer-implemented method of claim 11, wherein:
the central dispatcher is geographically remote from a plurality of geographically-separated data centers, and
the control information causes particular ones of the plurality of geographically-separated data centers to perform computer process in favor to other ones of the plurality of geographically-separated data centers based on a determination that the particular ones are more optimal for a defined criteria than are the other ones.

14. The computer-implemented method of claim 13, further comprising:
identifying at one or more of the multiple computer data centers that communication by the particular ones of the geographically-separated data centers with the central dispatcher has been interrupted, and
shifting over energy-using and energy-providing devices at the particular ones of the geographically-separated computer data center sites from global control to local control according to a predetermined control scheme.

15. The computer-implemented method of claim 14, further comprising:
identifying that communication with the central dispatcher has resumed,
providing to the central dispatcher information about current status of the particular ones of the geographically-separated computer data centers, and
receiving, in response and from the central dispatcher, information to cause continued future control of energy-providing and energy-using devices at the particular ones of the geographically-separated computer data centers.

16. The computer-implemented method of claim 11, wherein the plurality of power-supplying devices comprises distributed energy resources (DERs), and dispatching comprises virtually partitioning DER capacity for different uses in the computer data center.

17. The computer-implemented method of claim 11, further comprising updating a learning model of energy-using devices and energy-providing devices using data about recent performance by the devices, wherein the updating stores data indicative of how particular devices perform and parameters on which the devices perform.

18. The computer-implemented method of claim 11, further comprising scheduling dispatch of computing processes performed by the computer data center, so as to better meet cooling or electrical needs of the computer data center.

19. The computer-implemented method of claim 11, wherein scheduling the dispatch comprises load shaping according to a predetermined load profile.

20. The computer-implemented method of claim 19, wherein scheduling the dispatch comprises separately scheduling dispatch of computing processes for multiple different tenants in a multi-tenant computer data center.

21. The computer-implemented method of claim 11, further comprising:
identifying that the computer data center is in a degraded performance status, and
dispatching energy-using devices and energy-providing devices according to a predetermined low-energy safe-mode protocol in coordination with the reboot of the computer data center.
